(19) United States
(12) Patent Application Publication
(10) Pub. No.: US 2022/0005133 A1
(43) Pub. Date: Jan. 6, 2022

(54) METRIC BASED PROPERTY RATING AND CATEGORIZATION SYSTEM AND METHOD

(71) Applicant: Chunxiao Hou, New York, NY (US)

(72) Inventor: Chunxiao Hou, New York, NY (US)

(21) Appl. No.: 16/920,080

(22) Filed: Jul. 2, 2020

(51) Int. Cl. G06Q 50/16; G06Q 30/02

(52) U.S. Cl. CPC G06Q 50/16; G06Q 30/0278; G06Q 30/0282

(57) ABSTRACT

A metric based property rating and categorization system comprises data model, calculation and categorization engines and user interface logic. The data model describes the property attributes, categories and stats record information as well as their relationships. The calculation engine provides methods to generate metric scores and calculate property rating. The categorization engine is used to categorize a property to corresponding categories according to its characteristics. The user interface logic provides an interface accessible to a user to search and analyze property metrics, rating and category related information.

### FIELD OF THE INVENTION

The present invention relates to the field of real estate and software system.

The invention relates to the metrics used for property analysis.

The present invention is in relation to property categorization based on property characteristics.

The invention relates to the property rating based on metric scores.

### BACKGROUND

Regular residential real estate listing websites do not have metrics used for visualizing and analyzing property characteristics. There is no rating provided for each individual property based on its metric scores.

In addition they cannot sort properties based on certain metric or rating. For example, a user cannot sort properties by “Growth” metric and find fastest growing value properties by their metric scores.

Presently there is no solution to categorize properties based on their characteristics and a user cannot search properties by categories. For example, existing websites do not have the functionality for a user to search properties for sale from “low maintenance” category.

### BRIEF SUMMARY OF THE INVENTION

The present invention seeks to provide a solution to this problem(s) by providing a software system and methods that define, calculate and use metrics to analyze residential properties. It further provides an algorithm that uses property metric scores to calculate the overall rating of that property.

The present invention provides a system and methods to categorize properties into various groups based on their characteristics. In addition a user is able to search properties by the categorization result.

The present invention further provides a system that uses property rating and metrics to sort and compare properties.

### BRIEF DESCRIPTION OF THE DRAWINGS

FIG. 1 is a schematic representation of a rating and categorization system for processing real estate properties according to an exemplary embodiment.

FIG. 2 is a data model chart depicting the data structure and relationships for the system according to an exemplary embodiment.

FIG. 3 is a schematic representation of server components of the system according to an exemplary embodiment.

FIG. 4 is a flow chart depicting the rating and categorization process according to an exemplary embodiment.

FIGS. 5-11 show display screens provided by a user interface for the system according to exemplary embodiments.

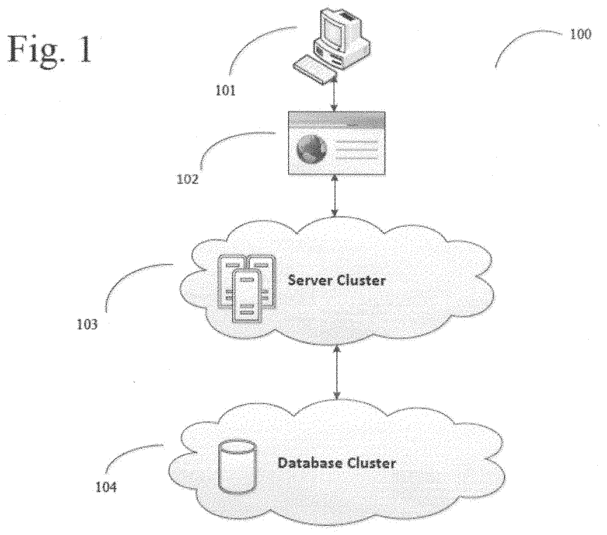

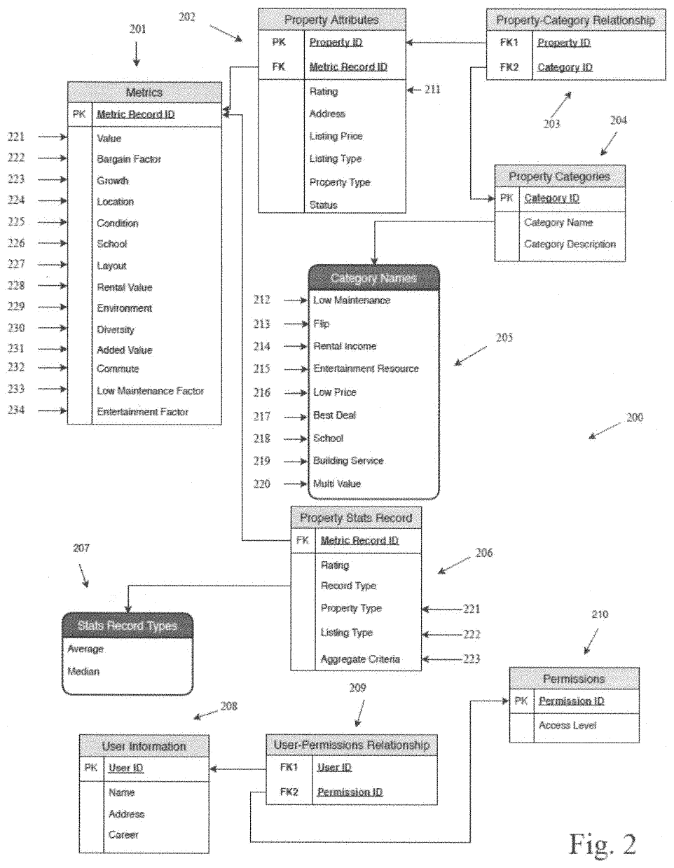

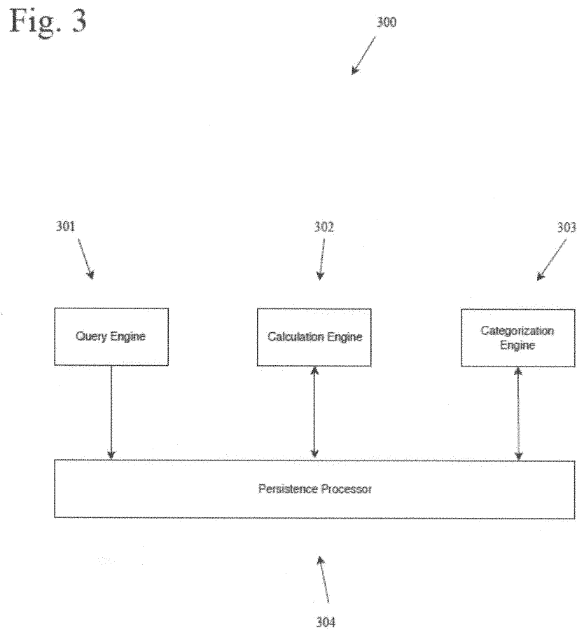

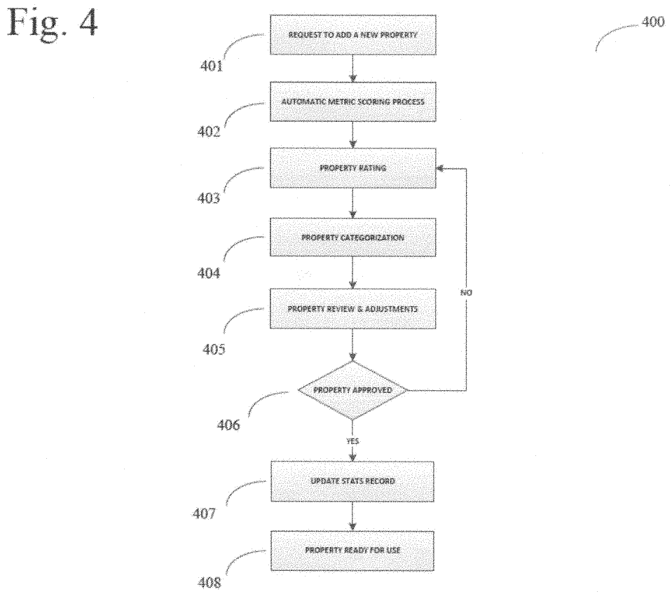

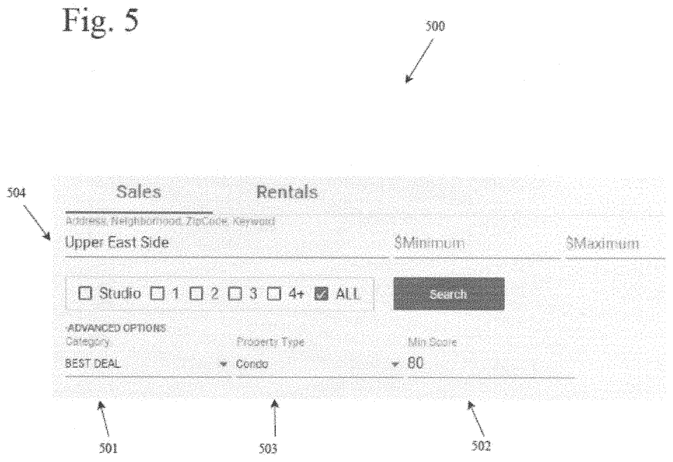

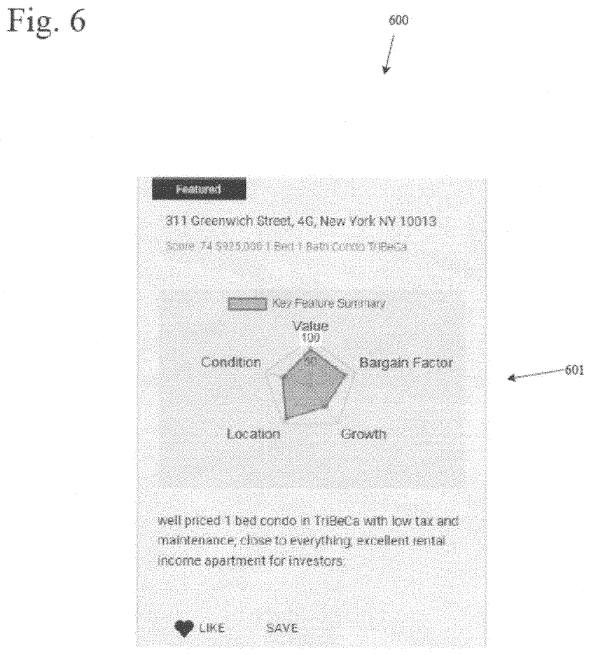

### DETAILED DESCRIPTION OF THE INVENTION

The software system includes database(s) 104, user interface (UI) 102, such as a website, and server(s) 103. The database(s) 104 is used to store and retrieve data and the server is to handle user request from a terminal 101, conduct calculations and interact with database(s) 104 directly.

### Database Data Model:

Either SQL or NoSQL database could be used and there could be one or multiple database 104 instances joined as a single cluster 104, but the data model 200 has four main areas:
Property Attributes 201 and 202
Property Categories 204 and 205
Property Stats Record 206 and 207
User Information and Permissions 208 and 210

### Property Attributes 201 and 202:

Each property is associated with a group of metrics 201 where a metric is a unique attribute that is used for measuring certain specific feature or characteristic of a property. Each metric defined below has a numerical score that has a minimum and maximum values. Metrics 201 are used for the overall rating 211 calculation, property categorization, analysis and visualization. Example metrics 201 of residential property are listed below:

Value: It 221 is an estimate of a property fair market value per square foot. Fair market value is defined as the price that a knowledgeable and willing buyer would probably pay to a knowledgeable and willing seller in the market. Both parties are behaving in their own interests.
Bargain Factor: It 222 describes a property offered for sale or rent more cheaply than its fair market value. The higher this metric value, the better it is for the buyer/tenant.
Growth: It 223 describes the potential process of increase in value of a property under estimated market condition in the next few years.
Location: It 224 estimates the quality of the neighborhood where a property is physically located. A property in premium location usually has high demand and better value resilience.
Condition: It 225 describes the state, especially with regard to the quality, appearance and working order of a property.
School: It 226 describes the education resources in the neighborhood of the target property.
Layout: It 227 describes the structure of a property and it could greatly affect the living quality and convenience level.
Rental Value: It 228 describes the estimated rental rate of return (ROI) and property liquidity in the market. This only applies to properties for sale.
Environment: It 229 describes the comfort and safety level for living in the neighborhood of the target property.
Diversity: It 230 describes the variety of demographic and life style in this neighborhood. A good diversified neighborhood tends to have stronger value resilience and liquidity thus reducing risks.
Added Value: It 231 describes additional features that can potentially add more value to a property, such as high floor apartment in Manhattan, HOA fee that includes all utility bills, etc.
Commute: It 232 describes the convenience level for accessing to popular work places, shops, and restaurants.
Low Maintenance Factor: It 233 describes the ease of maintaining a property in good condition in terms of cost. This only applies to properties for sale.
Entertainment Factor: It 234 describes entertainment resources such as bars, restaurants, drugstores, grocery stores, and shopping malls etc. This only applies to properties for rent.

In addition to metrics 201, a property has basic information 202 that contains fields, including, but not limited to, address details, neighborhood, property id, rating 211, amenities, property type, tax, home owners association (HOA) fee/common charge, listing price, and other supporting metadata. The property rating 211 is a numerical score with a minimum and maximum values.

### Property Categories 204 and 205:

A category consists of a group of properties that have certain unique characteristic in common and it is point of interest for a potential buyer or seller. A user is able to search properties by category(s) or combinations with other criteria. There are three types of categories including:

### Categories of Property for Sale 212 to 214:

Low Maintenance: It 212 describes properties with high score on “Low Maintenance Factor” metric.
Flip: It 213 defines properties with high “Bargain Factor” and low “Condition” scores.
Rental Income: It 214 describes properties that have excellent rating on “Rental Value” metric.

### Categories of Property for Rent 215 and 216:

Entertainment Resource: It 215 describes properties with high score on “Entertainment Activity Factor” metric.
Low Price: It 216 describes properties that have rental listing price that is significantly below average price in the same neighborhood.

### Categories of Property for Sale and Rent 217 to 220:

Best Deal: It 217 defines properties with high “Bargain Factor” score.
School: It 218 defines properties that have excellent rating on “School” metric.
Building Service: This 219 only applies to apartments in a building with common area and it offers excellent resource on amenities and services.
Multi Value: It 220 describes properties that have more than one category.

A property may belong to multiple categories 204 and 205 and a category may contain multiple properties. They are many-to-many relationship 203 that could be created, updated and deleted by invocation of corresponding database APIs.

### Property Stats Record 206 and 207:

The property stats record contains average and median 207 metric scores and rating for properties with the same grouping key which is consisted of three fields 221, 222 and 223:
Property Type 221: condo, co-op, condop, townhouse, single family house and multi-family house.
Listing Type 222: sale and rental
Aggregate Criteria 223: building, neighborhood, town, city, county and state. Each area might have different division hierarchy thus the criteria could vary on specific case.

Stats records 206 are calculated and grouped by each unique combination of above fields.

For each grouping key, there are a list of corresponding stats, including, but not limited to, average and median 207 values for each applicable metric and rating. The stats could be used to compare with individual property or cross comparison with different aggregate criteria 223.

### User Information and Permissions 208 to 210:

Every registered user to the software system has an account which includes:
Basic Personal Information: name, address and career etc.
Saved Search List: a user may save a search and subscribe to property updates from that search criteria. A search criteria comprises one or multiple searchable elements such as property neighborhood, category, rating, price range etc.
Saved Property List: properties that are saved by a user.

In addition it contains permission information 210 which defines the access level of a user to the software system. They include:
Access to browse and search properties
Access to save searches and properties
Access to edit user information
Access to edit basic property information
Access to edit property metric scores manually
Access to edit property category information
Access to edit property stats record
Access to edit another user permission

A user may have multiple access levels, and vice versa. It is many-to-many relationship 209.

### Server Architecture and Logic:

A software system running from a server or server cluster 103 has functionalities, including, but not limited to search, add, and update properties; calculate, query metric scores and rating; categorize properties; populate stats record; store and retrieve data from database(s). It comprises four main components:
Persistence Processor 304
Query Engine 301
Calculation Engine 302
Categorization Engine 303

### Persistence Processor 304:

The persistence layer is used to communicate between the application and database(s) 104. It provides generic APIs to create, query, update, and delete data from persistence storage. And it further supports concrete persistence implementations based on database types so it is easier to migrate to another storage engine without modifying other server components.

### Query Engine 301:

It 301 is used to transform a query request into internal metadata object, invoke persistence processor 304 API to query database(s) 104, process and return search result back to the user. There are four major types of query:
Property Search: It supports property search by its basic information. For example, it is able to return condo properties for sale in neighborhood Chelsea, N.Y.
Category Query: It is used to query properties by category 204. In addition a user can combine category query with property search and vice versa. For example, it can query properties for sale in category “Low Maintenance” 212 or “Best Deal” 217 for condos in neighborhood Upper West Side, N.Y.
Stats Record Query: This type of query is used to find stats record 206 by the stats grouping key described in the data model section. For example, given a condo property for sale in Chelsea, N.Y., this query engine is able to return average and median 207 property metric scores and rating for the building and Chelsea neighborhood where this property is located.
User and Permission Query: Given a user ID, it can query corresponding user information 208 and system access level(s) 210.

### Calculation Engine 302:

This software component 302 is used for populating initial metric scores 201 and calculating property rating 211. In addition it is responsible for updating the stats record 206 upon relevant property update.

Given a new property without metric scores 201 and rating 211, the calculation engine first generates stats grouping keys based on the property information and uses them to retrieve corresponding stats records 206 from the persistence processor 304. If records are found, the algorithm uses aggregate criteria 223 priority order to determine which record to use in order to populate the initial scores 201. The aggregate criteria could vary on specific case and an example is listed below:

Aggregate Criteria Priority (highest to lowest):
Building
Neighborhood
Town
City
County
State

Once the stats record is selected, the algorithm uses its metric average 207 values as initial metric scores 201 of the new property. If there is no matching record, configurable default values could be used as the initial scores. After review of these numbers, an authorized user may manually request to amend 405 them if necessary through user interface 102. As accumulation of stats data over time, the automatic process for generating metric scores becomes more accurate after each iteration. However for some metric, such as “Condition” 225, vary case by case thus an authorized and experienced real estate professional is typically required to review and make objective adjustments 405 on these numbers.

After metric scores 201 are populated, the calculation engine is able to calculate the rating 211 of the property. Metric scores of a property are represented as a vector where each element is a numerical value with a minimum and maximum values. Each metric has a corresponding configurable weight factor presenting lighter or heavier importance in the metric group. Similar to metric vector, weight factors form a weight vector. A weighted average formula is used to calculate the realized metric sum value and additional formulas used to calculate property rating are listed below:

$$• Metrics = ( {m}_{0} , {m}_{1} , … , {m}_{n - 1} , {m}_{n} ) where the maximum value of a metri c is defined as {m}_{max}$$

$$• Weights = ( {w}_{0} , {w}_{1} , … , {w}_{n - 1} , {w}_{n} )$$

$$• Realized Metric Sum = \frac{{\sum }_{i = 0}^{n} {m}_{i} {w}_{i}}{{\sum }_{i = 0}^{n} {w}_{i}}$$

$$• Metric Sum = \frac{{\sum }_{i = 0}^{n} {m}_{max} {w}_{i}}{{\sum }_{i = 0}^{n} {w}_{i}}$$

$$• Property Rating 211 = \frac{Realized Metric Sum}{Metric Sum} where 0 \leq Property Rating \leq 1$$

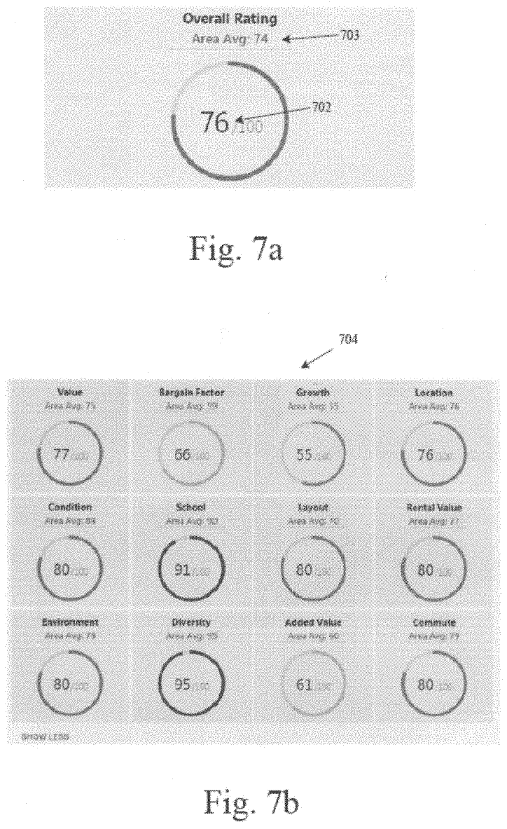

Upon metric score or weight update, it triggers calculation of property rating 211 and persists latest result to database(s) 104. If required, rounding and a multiplier could be applied to the rating value to scale it to the desired level for display or visualization purpose. For example a multiplier 100 is applied to the property rating 702 as shown in FIG. 7a.

The calculation engine triggers the logic to update corresponding stats records 206 when there is an update on metric scores 201 or property rating 211. It first generates stats grouping keys based on property information. Then it searches for exiting records and uses them to re-calculate average and median 207 values with latest property metric and rating information.

### Categorization Engine 203:

This software component is used to categorize properties to corresponding categories. Each category 204 has one or multiple filters and the algorithm applies them to a property to determine if it belongs to this category. A filter is a logical unit where it contains variables and functions which return a value or values in order to determine if the input passes the filter. Variables and functions defined in a category filter are reusable by another filter. And a filter is reusable by another category. A property belongs to a category if and only if it passes all filters of that category. The categorization engine goes through all available categories 204 and 205 and their filters to find matched categories of a given property. Examples of categories and their filters for property categorization are listed below:

### Variable and Function Definitions:

mₘₐₓ is defined as the maximum value of a metric
m_{metric name} represents the corresponding metric score of the given property
h is a configurable scale factor used as the threshold of a high score where 0≤h≤1
l is a configurable scale factor used as the threshold of a low score where 0≤l≤1
isSale(p) is a function that takes a property as input and returns true if this property is for sale otherwise it returns false which means this property is for rent
listingPx(p) returns the listing price of the given property
avgListingPx(p) is a function that takes a property as input and returns average listing price of similar active properties from the same neighborhood
categoryCount(p) returns current number of matched categories for a property
inBuilding(p) returns true if the property is an apartment in a building
amenity(p) returns the number of amenities the property or its building common area offers
totalAmenity(p) returns the maximum number of amenities a similar type of property may offer

Property Categories and Filter Definitions:
Low Maintenance 212: isSale(p)=true and m_{low maintenance factor}≥h mₘₐₓ
Flip 213: isSale(p)=true and m_{bargain factor}≥h mₘₐₓ and m_{condition}≤l mₘₐₓ
Rental Income 214: isSale(p)=true and m_{rental value}≥h mₘₐₓ
Entertainment Resource 215: isSale(p)=false and m_{entertainment activity factor}≥h mₘₐₓ
Low Price 216: isSale(p)=false and listingPx(p)≤l avgListingPx(p)
Best Deal 217: m_{bargain factor}≥h mₘₐₓ
School 218: m_{school}≥h mₘₐₓ
Building Service 219: inBuilding(p)=true and amenity(p)≥h totalAmenity(p)
Multi Value 220: categoryCount(p)>1

The categorization engine isn't limited to above categories 204 and 205 but rather it provides a generic framework to create any category, build filter(s) and categorize properties according to individual's specific needs and requirements. In addition it allows an authorized user to manually categorize a property to categories via user interface if required. It further provides façade APIs that mask interaction with complex components to improve simplicity and usability of the server(s) components.

### Rating and Categorization Workflow

When the server(s) 103 receives a request 401 to add a new property, it 402 first uses property stats record 206 to generate initial metric scores and use them to calculate the rating 403 as described in previous sections. Then the categorization engine applies filters of each category 204 to this property in order to determine what categories it belongs to 404. After this step, the property is in pending approval status and an authorized user is required to review 405 its metric scores 201, rating 211 and categories 204. The user is allowed to make objective adjustments 405 on metric scores 201 and basic property information 202 which triggers re-evaluation 403 and re-categorization 404 processes. This procedure 403 to 406 repeats until the user approves this property and its status becomes active 406. Then the calculation engine uses the final metric scores 201 and rating 211 to update the corresponding property stats records 407. And lastly the property is ready for use 408 by other components of the system. The above workflow 400 uses an iterative approach which allows the system to make automatic calculations and get feedbacks from an authorized and experienced real estate professional in order to enhance the model and data quality over each iteration, thus improving the automatic rating and categorization process accuracy.

### User Interface (UI):

It is used for property analysis via interaction between users and server components 300. Either a graphical user interface (GUI) or commend based interface could be used for the following main functionalities:
Search and Display Properties
Query and Display Categories
Property Management
Save Result Management

### Search and Display Properties:

Besides traditional search based on basic property information, it further supports searching by rating, metric and category 501 to 502. For example, a user can search properties with rating value above certain threshold 502 or query properties in “Best Deal” 217 category 501. A user may combine different search criteria to form a composite search 501 to 504.

The UI displays key metric 221 to 225 scores via a radar chart 601 in the property overview section 600. When a user navigates to the property detail section as shown in FIG. 7, it lists the rating 702 and metric scores 704 of that property and its neighborhood average values 703 and 704 for analysis and comparison purposes.

It has the option to use spreadsheets like table structure format 900 to display properties. Each column has a header 901 to 906 which maps to a metric 201, rating 211 or property basic information 202. Each row of the table represents a property. In addition it supports sorting properties in descending/ascending order 907 by selecting a desirable header 901 to 906. For example, a user is able to find fastest growing value properties by selecting metric “Growth” header in descending order.

The UI may show different colors for metric scores and rating in different ranges as shown in FIG. 7a and FIG. 7b. For example, for metric score with minimum value 0 and maximum 100, it shows dark green for score between 85 and 100; light green for score between 75 and 85; yellow for score between 60 and 75; orange for score between 50 and 60 and red for score between 0 and 50.

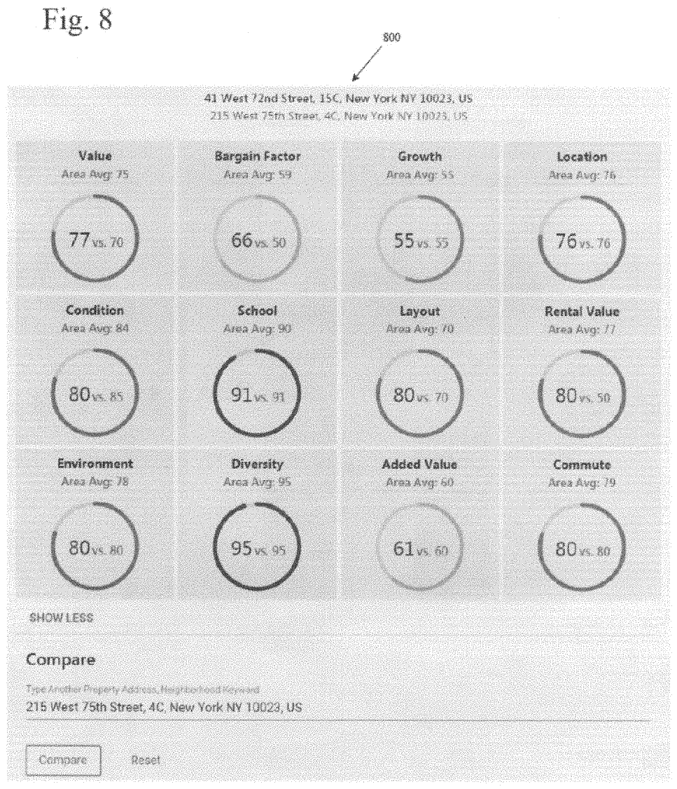

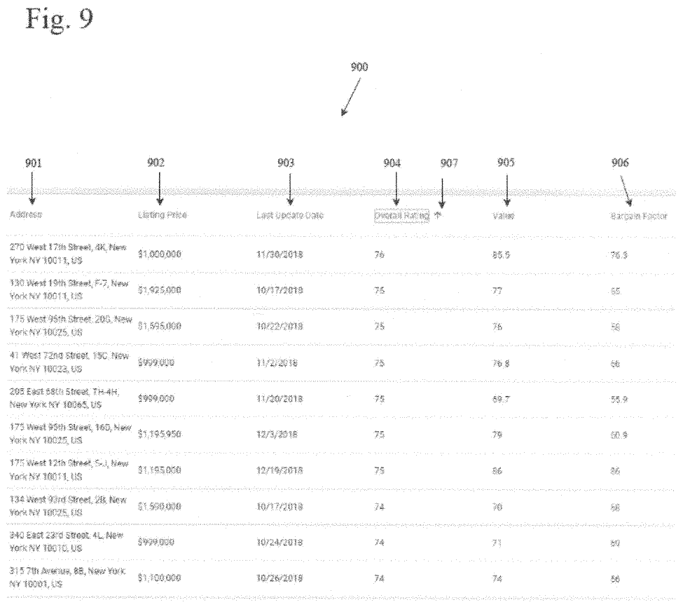

In addition it is able to compare a property rating and metrics with another property as shown in FIG. 8.

### Query and Display Categories:

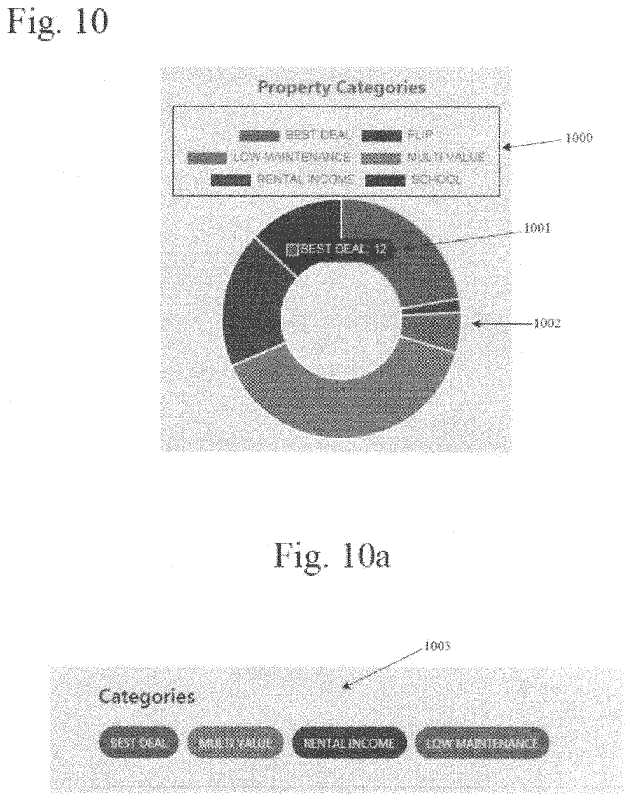

A visual format as shown in FIG. 10a, such as pie/donut chart 1002, may be used to display property category summary by listing all available categories 1000 and the number of properties in each category 1001. Each category has a selectable visual area which allows a user to select and further view all properties of that selected category. In addition it allows a user to search properties by category 501. Moreover when a user navigates to the property detail section, it shows available categories 1003 of that property and allows a user to select a specific category to further see all properties within that category.

### Property Management:

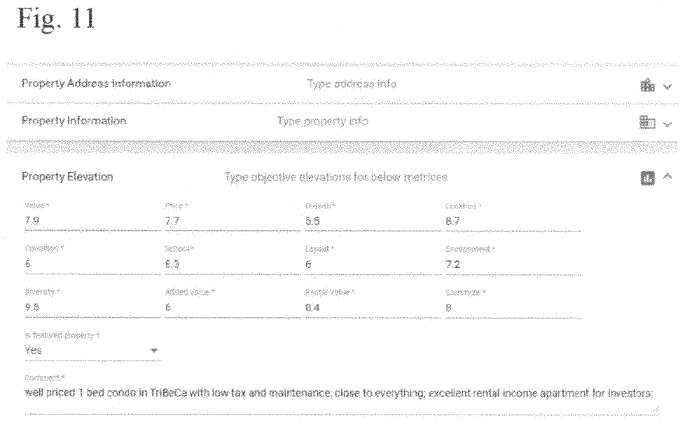

An authorized user may have the permission to edit property information as shown in FIG. 11, including, but not limited to basic information, metric scores and categories. The user might have the right to manually add a new property via UI although the server(s) provides API, such as RESTful API, to automatically accept property basic information feeds from a third party server.

### Save Result Management:

A user is able to save a category and subscribe to property update within that category. In addition a user is notified, for example via email notification, whenever there is an update. A search result may similarly be saved by a user. When a property is saved, a user is only notified when that specific property has an update.

While at least one exemplary embodiment has been presented in the foregoing detailed description in connection with specific apparatus and applications, it should be understood that a vast number of variations exist. The exemplary embodiment is merely an example to explain the principles of the invention, and is not intended to limit the scope, applicability, or configuration in any way. Rather, the foregoing description will provide those of skill in the art with a convenient road map for implementing an exemplary embodiment of the invention. It will be understood that many modifications and variations may be made in the function and arrangement of elements described in an exemplary embodiment without departing from the scope of the invention as set forth in the appended claims.

### REFERENCES (INCORPORATED HEREIN BY REFERENCE)

1. Arpin; Jeffrey L. (Vienna, Va.), Dick; Michael W. (Arlington, Va.), Edgar; Thomas P. (Vienna, Va.), Hunt; Brian(Olney, Md.) 2010, “Property investment rating system and method”, U.S. Pat. No. 7,813,990
2. Sedota, Jr.; Donald James (Mount Pleasant, S.C.), Bane; Cooper Howard (Charleston, S.C.), Allen; Elliot Grier (Mount Pleasant, S.C.), McGuier; Andrew Abraham (North Charleston, S.C.), Green; Bryan Christopher (Goose Creek, S.C.) 2013, “System and method for prioritizing real estate opportunities in a lead handling system based on weighted lead qualityscores”, U.S. Pat. No. 8,666,792
3. JAGDEV; Sujit Pal Singh; (Pickering, Calif.); DEVADASON; Christopher Paul; (Pickering, Calif.); SAYANY; Salman Ashiqali; (Pickering, Calif.); PALLANIK; Kyle Robert Joseph; (Pickering, Calif.); ELLENS; James Kenneth; (Pickering, Calif.) 2015, “METHOD AND SYSTEM FOR REAL ESTATE VALUATION”, 20180232784
4. Smith; Creed; (Denver, Colo.), 2015, “Automated Real Estate Valuation System”, 20160292800
5. Vergano; Sandy; (Oakland, Calif.) 2015, “METHOD AND SYSTEM FOR ENHANCING REAL ESTATE VALUE”, 20150332179
6. Coats; Walt; (Golden, Colo.); Gregg; Gary; (Denver, Colo.); Agnes; Brian; (Denver, Colo.); Ferguson; Gary; (Erie, Colo.) 2014, “SYSTEM AND METHOD FOR REAL ESTATE VALUATION”, 20140279572
7. Herzberg; Kenneth L.; (New York, N.Y.); Herzberg; Andrew J.; (New York, N.Y.) 2011, “SYSTEM, METHOD, AND PRODUCT FOR PROTECTING A REAL ESTATE VALUE”, 20110178952
8. Burns; James M.; (Huntington, N.Y.) 2006, “System and Method for Determining a Real Estate Property Valuation”, 20080301064

What is claimed is:

1. A method of calculating a property rating based on metrics, the method comprising:
(a) metrics used to quantify property characteristics
(b) property stats record used to automatically generate property metric scores
(c) formulas for calculating property rating

2. A method of property categorization, the method comprising:
(a) property categories
(b) property category filters
(c) categorizing properties to corresponding categories

3. A system for property analysis based on property metrics, rating and categories, the system comprising:
(a) a table structure allowing a user to sort properties by metrics and rating
(b) means for using a radar chart to display a property key metrics
(c) property category summary
(d) means for using category to view properties
(e) means for displaying categories of a property
(f) means for comparing a property metric scores and rating with another property or its neighborhood average values

4. A method of improving automatic rating and categorization process accuracy, the method comprising:
(a) review and adjustments on metric scores by an authorized user
(b) an iterative approach to improve automatic rating and categorization process accuracy

5. A method as claimed in claim 1, wherein each metric is associated with a numerical score which has minimum and maximum values.

6. The property stats record according to claim 1, wherein it contains average and median metric scores and rating of properties with the same grouping key which comprises property type, listing type and aggregate criteria.

7. A method as claimed in claim 1, wherein the property stats record has functionalities comprising:
(a) automatically generating metric scores for a new property
(b) providing metric and rating average and median values for a given grouping key
(c) updating stats record in claim 6 by property metric and rating updates

8. A method as claimed in claim 2, wherein a property category contains multiple properties and vice versa.

9. A method as claimed in claim 2, wherein a category has multiple filters and each filter returns a value or values which are used to determine if a property belongs to that category.

10. A method as claimed in claim 2, wherein variables and functions defined in a category filter are reusable by another filter.

11. A method as claimed in claim 2, wherein filters defined in a category are reusable by another category.

12. A method as claimed in claim 2, wherein the categorization engine applies filters of each category to this property in order to determine what categories it belongs to.

13. The property category summary according to claim 3, wherein it lists available categories and the number of properties in each category.

14. The property category summary according to claim 3, wherein it is shown in a visual and/or indicia format.

15. The property category summary according to claim 3, wherein each category has a selectable visual area which allows a user to select and further see properties of that selected category.

16. A method as claimed in claim 3, wherein the property detail section shows available categories of a property and a user is allowed to select a category to further see properties of that selected category.

17. A method as claimed in claim 3, wherein the table structure lists properties as rows and a property maps to one row.

18. The table structure as claimed in claim 3, wherein it has selectable headers and each column maps to one header which is associated with a property metric, rating or property basic information.

19. The table structure as claimed in claim 18, wherein a user can sort properties by selecting a desirable header of that table.

20. The method as claimed in claim 4, wherein the review and adjustments on metric scores may be made after generating the initial metric scores by the calculation engine as claimed in claim 7.

21. The iterative approach according to claim 4, wherein it comprising the steps of:
(a) generating the initial metric scores for a new property by the calculation engine as claimed in claim 7
(b) calculating the property rating by the calculation engine as claimed in claim 1
(c) categorizing the property by the categorization engine as claimed in claim 12
(d) review and adjustments on metric scores by an authorized user as claimed in claim 20
(e) going back to step (b) if there is any change made to the metric scores from step (d); otherwise going to step (f) after the property is approved
(f) updating the property stats record using latest property metric scores and rating as claimed in claim 7
